(19) United States
(12) Patent Application Publication
(10) Pub. No.: US 2025/0014089 A1
(43) Pub. Date: Jan. 9, 2025

(54) SYSTEMS AND METHODS FOR PROFILE-BASED SERVICE RECOMMENDATIONS

(71) Applicant: Jonathan McClure, Miami, FL (US)

(72) Inventor: Jonathan McClure, Miami, FL (US)

(21) Appl. No.: 18/764,904

(22) Filed: Jul. 5, 2024

Related U.S. Application Data
(60) Provisional application No. 63/512,018, filed on Jul. 5, 2023.

(51) Int. Cl. G06Q 30/0601; G06Q 30/0201; H04L 67/306

(52) U.S. Cl. CPC G06Q 30/0631; G06Q 30/0201; H04L 67/306

(57) ABSTRACT

Systems and methods for performing profile-based recommendations including receiving a user input from a user, extracting a query from the user input, identifying at least one category based on the user input, generating a user profile representative of the query and preferences of the user, retrieving data corresponding to services in the identified at least one category from a data source and generating a service profile for each respective service, determining a match between the user profile and the service profiles, generating, in response to the query, an output dataset corresponding to one or more service profiles in the at least one category determined from the matching. The services corresponding to at least one of services of a third party service provider, a location, and an objective.

### CROSS-REFERENCE TO RELATED APPLICATIONS

The present application claims priority to and benefit of U.S. Provisional Patent Application No. 63/512,018, filed Jul. 5, 2023, and entitled “SYSTEMS AND METHODS FOR PROFILE-BASED SERVICE RECOMMENDATIONS,” the entirety of which is herein incorporated by reference.

### TECHNICAL FIELD

The instant disclosure relates to recommending services to users based on profiles.

### BACKGROUND

Many service providers recommend various services to users in order to, among other reasons, introduce the users to services they may not otherwise be aware of, services that the users would enjoy, or services that would be especially profitable to the service providers.

### BRIEF DESCRIPTION OF THE DRAWINGS

FIG. 1 is a block diagram of an example system for providing profile-based service recommendations.

FIG. 2 is a flow chart illustrating an example method of providing profile-based service recommendations.

FIG. 3 is a flow chart illustrating an example method of providing profile-based service recommendations.

FIG. 4 is a flow chart illustrating an example method of providing profile-based service recommendations.

FIG. 5 is a flow chart illustrating an example method of providing profile-based service recommendations.

FIG. 6 is a flow chart illustrating an example method of obtaining data of service providers from a data source.

FIG. 7 is a flow chart illustrating an example method of obtaining data of service providers from a data source.

### DETAILED DESCRIPTION

Generally, service providers-such as travel brokers or websites-suggest services to users as users work to plan their trips. For example, a travel website may suggest a particular hotel for a user after that user selects flights, with the hotel suggestion based on the dates and destinations of the flights. In another example, a travel broker may be incentivized (e.g., by an airline) to book travel for users to a particular destination, so the travel broker may suggest flights to the particular destination. In both of these examples, the suggestions made are agnostic to any particulars (e.g., preferences, demographics, requirements, etc.) for the user. When service providers do make personalized recommendations, they are typically based on past user history, such that the service provider may recommend the same hotel that the user stayed in on their last visit. These types of recommendations are not truly personalized, but instead exhibit a standard sort of pattern detection and recall.

Accordingly, current service recommendation systems fail to account for personal details, ignore users individually, and are restricted to making recommendations from static data of the current service recommendation systems or a network of the current recommendation systems. Current recommendation systems also fail to identify gaps between user inputs and the data. That is, current recommendation systems provide recommendations from static data that fail to reflect current and/or future circumstances and may not be fully responsive to a user's queries due to the static data being utilized lacking such information. Although static datasets may be updated periodically with new data, current recommendation systems fail to identify gaps in the data used for providing the recommendations, and fail to retrieve data from other data sources external to the current recommendation system, or external to a network of the current recommendation system, to resolve the identified gaps between the user inputs and the data. Instead, these gaps are manually filled by, for example, an entity of the current recommendation system.

Current recommendation systems provide recommendations using the static datasets and are limited by these static datasets until the data is updated. The recommendations provided by the current recommendation systems may thereby fail to meet user's expectations by failing to account for users individually, failing to account for current and/or future circumstances, failing to obtain relevant data in response to identifying the gaps, among other like reasons. Although the data utilized by these current service recommendation systems may be periodically updated, the recommendations provided to users by current service recommendation systems are not customized to users individually and fail to provide recommendations from real-time, or live, data in response to the user's inputs and/or preferences.

The systems and methods described herein provide a solution to this deficiency by generating a profile for each user based on each user's specific tastes and preferences. Each user profile is generated in response to user inputs representative of a query for recommendations from the user at, for example, a web browser or other inputs from the user. These tastes and preferences may be established in the generated user profile based on a review of the user's travel history, browser interactions, etc., and may include different types of user inputs such as, for example, text, audio (e.g., user's voice), browser interactions (e.g., clickstream), and other like inputs, which may be representative of the user's inputs as answers to a questionnaire with wide-ranging questions. The user's profile may then be used to populate service profiles of third party service providers in a variety of possible service categories determined based on the user's input and/or query. The user's profile may then be compared to the set of service profiles generated for each of the variety of possible services or service categories. These service profiles may be generated by pulling numerical and narrative-based data from available sources, such as websites or visitor guides, and may be continuously refreshed as more data becomes available (e.g., a new hotel begins to get more reviews, a restaurant has permanently closed, a festival being held in a city next month, etc.). Service profiles that “match” the user's profile may then be recommended to the user. These profiles may be generated by one or more machine learning models, and the matching may involve similarity calculations for embeddings representative of the generated profiles. For example, a user profile is matched to one or more service profiles based on a distance metric calculated for embeddings representative of the user profile and the respective embeddings representative of each service profile.

The profile-based recommendations may be provided by the recommendation system using data obtained from a data source. The data source may be from a memory of the recommendation system, from a data store in a network of the recommendation system, from one or more networks external to the network of the recommendation system, or any combination thereof. The data may then be stored at the recommendation system or in the network of the recommendation system such as, for example, a data store therein. The one or more networks may include a respective network of a third-party service provider. The one or more networks may include, for example, a network of a search engine that provides data corresponding to the third-party service providers in response to queries for such data from the recommendation system. The recommendation system may thereby retrieve this data by scraping the data output by the search engine of the other network computing device. In some embodiments, the data may include a large corpus of data including, for example, electronic documents representative of web pages, images, videos, audio recordings, and other types of data.

The recommendation system may apply one or more model techniques and/or methodologies to the retrieved data to parse through the data based on context learned from the user profile to generate summaries of the corpus of retrieved data that may be responsive to the user inputs. For example, the recommendation system may generate a summary of one or more electronic documents in the corpus based on the context of the documents. In another example, the recommendation system may identify, based on the context, an electronic document in the corpus including therein information related to an objective of the query from a user and may generate a summary for the electronic document. The recommendation system may generate the service profiles based on these summaries.

The recommendation system may apply the one or more model techniques and/or methodologies to the retrieved data and/or the data output by the model multiple times to refine the retrieved data and to generate the summaries. The models may refine the retrieved data and/or previous summaries based on at least one of the user inputs, user profile, context parameters, model prompts, other model parameters, or any combination thereof, to generate specific summaries in response to the user's inputs such as, for example, for recommendations for service profiles representative of points of interest in a particular city.

The retrieved data may be utilized to generate service profiles of third party service providers. The retrieved data, or portions thereof, may also be stored locally in a data store of the recommendation system or a network of the system. In this regard, the locally stored data may be utilized by the recommendation system to perform the profile-based recommendations. In some embodiments, the data may correspond to user profiles, user preferences, user inputs, retrieved data, service profiles, summaries, other like data, portions thereof, or any combination thereof, and may be utilized by the recommendation system to perform the profile-based recommendations. For example, the recommendation system may utilize the locally stored data if a time period for retrieving data from one or more of the other network(s) exceeds a certain threshold. In another example, the recommendation system may utilize the locally stored data based on a determination by the one or more models that the data may be utilized to fulfill the query.

The data stored in the memory of the recommendation system or a network of the recommendation system may be, for example, a vector dataset. In some embodiments, the data may correspond a large corpus of data such as, for example, electronic documents, image data, video data, audio data, other types of data, or any combinations thereof retrieved from other networks via data scraping. In some embodiments, the data may correspond to user profiles, user preferences, summaries, service profiles, weights, parameters, feedback data, or any combination thereof, among other data.

The locally stored data may be continuously updated with new data retrieved from the other networks, new profiles generated by the recommendation system in response to fulfilling queries, feedback data, portions thereof, or any combination thereof, among other data. The recommendation system can utilize this data to perform the profile-matching including to generate service profiles in response to user inputs. The recommendation system may leverage the vector dataset if the data therein is identified as being related to the user input or if the data therein can be utilized to fulfill the query. For example, the current recommendation system may, in response to a request for recommendations for local florists in a particular area, can retrieve relevant data from the data store of the recommendation system. In another example, the recommendation system may utilize the locally stored data at the recommendation system if the time period for retrieving the data from the other networks exceeds a certain threshold.

In this regard, the embodiments in the present disclosure may be capable of performing dynamic matching of user profiles and service profiles for the purposes of fulfilling user inputs corresponding to a query for one or more categories of services with improved accuracy and efficiency. That is, the service profiles in a particular category may be determined based on real-time data retrieved from sources including at least one of data stores in the recommendation system or in a network of the recommendation system, data stores of other networks, the third party service provider device, other devices, or any combination thereof.

The one or more machine learning techniques and/or algorithms may be utilized to perform the profile-based recommendations including, for example, extracting queries from user inputs, generating a user profile based on the extracted query and the user's preferences, identifying categories, retrieving data from a data source based on the identified categories, generating service profiles according to the identified categories from the retrieved data, and matching the user profile to the generated service profiles to provide the user with one or more service profiles as recommendations that the user is predicted to interact with based on the characteristics in the service profile and based on the user's parameters, among other operations.

The various embodiments of the present disclosure are directed to improvements in the functionality of a computing device by leveraging trained models for providing profile-based recommendations between a particular user profile and one or more service profiles determined based on the user's inputs, the service profiles being generated based on real-time data. Service profiles determined to be matching the user profiles can be sent to the user device as output and displayed at the user device. The user's interaction with the displayed service profiles can then be obtained as feedback to further train the models and to improve subsequent operations.

Accordingly, the service profiles being provided to users in response to their queries can be determined from recently retrieved data extracted from, for example, other web pages. Rather than utilizing only static datasets, the recommendation system being capable of retrieving recent data from the other data sources improves the relevancy of recommendations provided to users based on this data by including current and/or future events. The recommendation system described herein may also improve upon gaps identified between the user profile and the retrieved data by generating new or refined queries for relevant data that can then be retrieved and applied to the models to generate service profiles that have a higher relevancy to user queries that may fill the identified gap. In some embodiments, the identified gaps may be due to the content of the locally stored data. In other embodiments, the identified gaps may be based on content of the data retrieved from the other data source(s), e.g., other network(s). Accordingly, the improvements include the recommendation system being able to provide improved service profiles in response to user queries that may be a better match for the user profile.

Although reference is made throughout to the services being travel-based services, such as flights, hotels, restaurants, and excursions, the embodiments discussed herein should not be read as limited to travel-based services, and should instead be read to include any type of service that could be provided. For example, the systems and methods described herein should be read as applicable to maintenance services (e.g., plumbers, electricians, lawn care, etc.), education services (e.g., college selection, tutors), wedding services (e.g., florists, officiants, etc.), investment opportunities (e.g., portfolios, venture capital), funding sources (e.g., loans, lines of credit), and more.

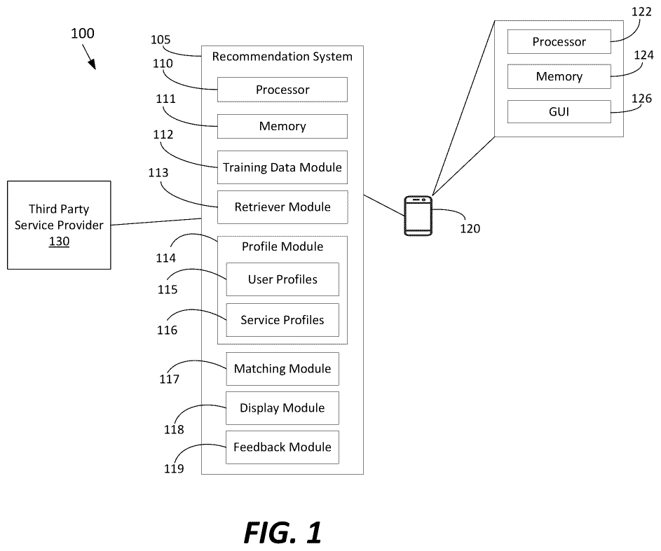

Referring to the drawings, wherein like reference numerals refer to the same or similar features in the various views, FIG. 1 is a block diagram of an example system 100 for providing service recommendations. The system 100 may include a recommendation system 105, a user device 120, and a third party service provider 130. Each of the recommendation system 105, the user devices 120, and the third party service provider 130 may be in electronic communication with one another and/or with other components via a network. In some embodiments, the system 100 may include the network to enable for electronic communication between components therein. The network, although not shown in the figures, may include any suitable connection (or combinations of connections) for transmitting data to and from each of the components of the system, and may include one or more communication protocols that dictate and control the exchange of data.

The recommendation system 105 includes the recommendation system 105. The recommendation system 105 may include one or more computing devices associated therewith for performing the profile-based recommendations. For example, the recommendation system 105 may be capable of handling a high volume of queries in parallel by distributing the processing tasks across the respective devices.

The system 100 includes a user device 120. in electronic communication with the system 100 and/or the recommendation system 105. In some embodiments, a plurality of user devices 120 may be in electronic communication with the system 100 and/or the recommendation system 105. The system 100 includes a third party service provider 130 in electronic communication with the system 100 and/or the recommendation system 105. In some embodiments, a plurality of third party service providers 130 may be in electronic communication with the system 100 and/or the recommendation system 105. In some embodiments, the user devices 120 and the third party service providers 130 may be in one or more other networks, and may be in electronic communication with each other, with other components in a same network, and with components in other networks including, for example, the recommendation system 105 in the network of system 100. For example, the third party service provider 130 may be a travel agent service, and the user device 120 may be in electronic communication with a network of the recommendation system 105 via a network of the third party service provider 130 using APIs.

As shown, the recommendation system 105 may include one or more functional modules 112, 113, 114, 117, 118, and 119 embodied in hardware and/or software. In an embodiment, the functional modules 112, 113, 114, 117, 118, and 119 of the recommendation system 105 may be embodied in a processor 110 and a memory 111 (i.e., a non-transitory, computer-readable medium) storing instructions that, when executed by the processor 110, cause the recommendation system 105 to perform the functionality of one or more of the functional modules 112, 113, 114, 117, 118, and 119 and/or other functionality of this disclosure.

Each of the user devices 120 may include a processor 122 and a memory 124, which may be any suitable processor and memory. In particular, the user devices 120 may be mobile devices (e.g., smartphones, tablets, laptops, etc.) and/or immobile devices (e.g., kiosk, fixed computer, etc.). The memory 124 may store instructions that, when executed by the processor 122, cause a graphical user interface (GUI) to display on the user device 120. This GUI 126 may include or rely upon one of the modules of the recommendation system 105 (e.g., display module 118) and may leverage and/or communicate with the third party service provider 130. For example, the GUI 126 may enable the user to interact with one or more services offered by the third party service provider 130.

The functional modules 112, 113, 114, 117, 118, and 119 of the recommendation system 105 may include a training data module 113 configured to retrieve data regarding one or more services associated with one or more users, and to generate training data for a machine learning model based on that retrieved data. The data may include, but is not limited to, text data, image data, audio data, interaction data, clickstream data, completed transaction data, personal data, account data, historical data, metadata, attributes, weights, other data, or any combination thereof. The training data module 113 may be configured to train models for performing the profile-based recommendations including, but not limited to, obtaining user inputs from a user, extracting a query from the user inputs, generating a user profile based on the query and the user's preferences, identifying categories based on the query, retrieving data of third party service providers 130 including associated characteristics, generating service profiles representative of the third party service providers 130, and matching the user profile with the service profiles.

Various embodiments herein can employ artificial-intelligence, machine learning models, large language models, neural network models, deep learning neural network models, deep q-learning neural network models, and/or other machine learning systems and techniques to facilitate providing models for performing the profile-based recommendations in accordance with the present disclosure. For example, the training data module 113 may include an A.I. chatbot model that utilizes natural language processing (NLP) to understand and respond to user input including at least one of text, images, audio, other data, or any combination thereof, and generate data corresponding to matching service profiles in response to the user input, the service profiles including at least one of text, images, audio, other data, or any combination thereof.

In some embodiments, the training data module 113 may train the models using prompt engineering techniques and/or methodologies to provide optimal outputs in response to user inputs. Prompt engineering may be utilized to enable the models to interpret and understand the user inputs including a context thereof, identify categories, generate a query based on the user inputs and based on the user's preferences for retrieving data in the identified categories, generate a user profile, parse through the retrieved data to generate service profiles representative of third party service providers 130 matching the user profile. In some embodiments, the queries and data retrieved in response to the queries may be obtained using an API. In some embodiments, parsing through and refining the retrieved data may include applying one or more model techniques and/or methodologies to determine relevant portions of data, generate summaries of the data, and identify third party service providers 130 candidates for generating the service profiles. The third party service provider 130 candidates can be identified based on at least one of the user profile, retrieved data, generated summaries, other data, or any combination thereof, based on the parsing or refinement techniques of the models. For example, one or more of the third party service providers 130 can be identified in the generated summaries based on a number of instances the respective third party service providers 130 is referred to in the data therin. In another example, the retrieved data may correspond to several webpages and the third party service provider 130 candidates can be identified based on the number of instances in the webpages that reference the respective third party service providers 130.

In some embodiments, training data module 113 may train the models (e.g., via supervised and/or unsupervised techniques) to perform one or more of the above or below-described functions using training data including various context conditions that correspond to various management operations. In one example, an A.I. and/or M.L. model can further learn (e.g., via supervised and/or unsupervised techniques, prompt engineering, linear regression, etc.) to perform the above or below-described functions using training data including feedback data, where such feedback data can be collected and/or stored (e.g., in memory 111) by training data module 113. In this example, such feedback data can include the various instructions described above/below that can be input, for instance, to a system herein, over time in response to observed/stored context-based information.

Although the one or more embodiments are described in the present disclosure in the context of profile-based recommendations, it is to be appreciated that the various embodiments can be utilized in a networked system such as, for example, system 100 for any of a plurality of purposes including, for example, maintenance services, education services, wedding services, investment opportunities, funding sources, among other purposes, the system 100 being capable of taking automated actions with high degrees of confidence in response to user inputs in the recommendation system 105. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, of system 100 and/or recommendation system 105 herein can include artificial intelligence component(s) which can employ an artificial intelligence (AI) model, machine learning model, or neural network or a neural network mode that can learn to perform the above or below described functions (e.g., via training data and/or feedback data).

A.I./M.L. components herein can initiate an operation(s) associated with the one or more functional components 112, 113, 114, 117, 118, 119 of the recommendation system 105 based on a defined level of confidence determined using information (e.g., feedback data). For example, based on learning to perform such functions described above using feedback data, performance information, and/or past performance information herein, the trained models herein can initiate an operation associated with providing service profile recommendations as output predictions based on input data applied to the model.

In an embodiment, trained models can perform a utility-based analysis that factors cost of initiating the above-described operations versus benefit. In this embodiment, an artificial intelligence component can use one or more additional context conditions to determine an appropriate distance threshold or context information, or to determine an update for a tuning model. In some embodiments, the one or more models can initiate operations with the one or more functional components 112, 113, 114, 117, 118, 119 of the recommendation system 105 separately in granular parts to help achieve enhanced model focus and to improve the accuracy of the outputs.

To facilitate the above-described functions, trained models herein can perform classifications, correlations, inferences, and/or expressions associated with principles of artificial intelligence. For instance, trained models can employ an automatic classification system and/or an automatic classification. In one example, the trained models in recommendation system 105 can employ a probabilistic and/or statistical-based analysis (e.g., factoring into the analysis utilities and costs) to learn and/or generate inferences. The trained models can employ any suitable machine-learning based techniques, statistical-based techniques and/or probabilistic-based techniques. For example, the techniques employed by the trained models can include supervised learning, reinforcement learning, unsupervised learning, deep learning, clustering, neural networks, support vector machines (SVM), expert systems, fuzzy logic, Hidden Markov Models (HMMs), greedy search algorithms, rule-based systems, Bayesian models (e.g., Bayesian networks), data fusion, utility-based analytical systems, other non-linear training techniques, or any combination thereof. In an example, the trained models can perform a set of machine-learning computations. For instance, the trained models can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In some embodiments, the models can utilize one or more natural language processing (NLP) techniques including, but not limited to, text summarization, sentiment analysis, lemmatization, named entity recognition, anchoring, rapport, mirroring, meta model, other language processing techniques, or any combinations thereof. The one or more models may leverage the one or more natural language processing (NLP) techniques to receive input data from users, extract a query from the user input, retrieve data of the services in the identified category or categories from one or more other networks, generate profiles for the user and/or the service providers based on attributes in the text data, among other operations. For example, the trained model can scrape text data from web pages in a web browser at a computing device of system 100 and/or recommendation system 105, or in a network associated with recommendation system 105, and can extract the data of the service providers from the scraped data.

In some embodiments, the models can utilize one or more clustering techniques including, but not limited to, density-based clustering, distribution-based clustering, centroid-based clustering, hierarchical based clustering, or any combinations thereof. In addition, the one or more models can apply one or more clustering algorithms including, but not limited to, k-means clustering algorithms, density-based clustering algorithms, Gaussian mixture model algorithms, balanced iterative reducing and clustering using hierarchies (BIRCH) algorithms, propagation clustering algorithms, mean-shift clustering algorithms, order point clustering, agglomerative hierarchy clustering algorithms, other algorithms, or any combinations thereof. For example, the trained model can apply the one or more centroid-based clustering models to determine clusters using k-means clustering algorithms.

The functional modules 112, 113, 114, 117, 118, and 119 of the recommendation system 105 may include a retriever module 113 configured to retrieve data from a data source based on the user inputs. The retriever module 113 may be configured to generate a query to retrieve data from a data source based on the user inputs. In some embodiments, the query may be a dynamic query generated based on applying the one or more model techniques and/or methodologies to the user inputs to determine the purpose or objective of the user's request based on a context of the data. In some embodiments, the request may be generated from an initial user input query. In other embodiments, the request may be a reformed query generated from follow-up responses from the user as a result of the initial request failing to retrieve relevant data. In this regard, the profile module 114 and/or the recommendation system 105 may generate follow-up responses that may be provided to the user device 120 to obtain additional input data from the user to reform the request.

The data store may be in a network of the recommendation system 105. In some embodiments, the data store may be in another network such as, for example, a network of the third party service provider 130. The retriever module 113 and/or the recommendation system 105 may send queries and receive data in response to the queries using APIs. In this regard, the profile module 114 may be configured to structure queries according to different API specifications and to enable adding new APIs to expand the capabilities of the recommendation system 105.

In some embodiments, the retriever module 113 may retrieve a corpus of data from the data source in response to the query. The retriever module 113 may, based on the query, extract data from the corpus of data that may be relevant to the query. In some embodiments, the extracted data, or portions thereof, may be regarding the third party service provider 130 in an identified category. For example, the data of a third party service provider 130 may be scraped from data corresponding to multiple webpages.

The data being retrieved may include, for example, webpages or other electronic documents. In some embodiments, the data can include text data, image data, video data, audio data, other types of data, or any combinations thereof. For example, the data may include, but is not limited to, electronic documents, emails, HTMLs, MOVs, MPEGs, JPEGs, WAVs, MP3s, other formats, or any combinations thereof. In some embodiments, the data regarding the one or more third party service providers 130 may be retrieved by the retriever module 113 based on the identified category (or categories) from the input data. For example, the data regarding the one or more services in a particular category may be extracted from webpages (e.g., data scraping) using a machine learning model.

The functional modules 112, 113, 114, 117, 118, and 119 of the recommendation system 105 may include a profile module 114 configured to generate user profiles 115 indicative of preferences and characteristics of respective users and service profiles 116 indicative of characteristics of respective services. The profile module 114 may utilize the models to process the user input data to determine a user sentiment based on a context of the user input data, and to leverage the determinations to identify an objective of the user, generate the query for retrieving data, generate a user profile 115, identify categories for service profiles 116, and to generate service profiles 116 from the retrieved data. In some embodiments, the service profiles 116 may include therein one or more portions of data extracted from the corpus of data. The data portions may, for example, correspond to the user inputs, the user profile, or other characteristics that may promote user interaction with the service profile.

The profile module 114 may be configured to utilize the models to gather information including identifying a user account of the user providing the input to the recommendation system 105, retrieving historical data including, for example, past conversation history for relevant requests, partitioning the user input into multiple messages for complex tasks.

The profile module 114 may be configured to utilize the models to perform data analysis including understanding requests, identify gaps in information, generating follow-up responses to the user if additional data is needed. For example, the model may generate a follow-up response to a user input asking, “help me find a restaurant?” in which no date or location is provided. The models may also be configured to decide when not to generate follow-up responses to user inputs. For example, the trained model may not generate a follow-up response to a user input asking, “I am looking for dinner tonight in London near Mayfair.” Although the time is not provided and the person may not have an existing profile in the recommendation system 105, the recommendation system 105 may be capable of generating an answer to the query and may also refine the results as needed after an initial recommendation based on the training data of the model.

The profile module 114 may utilize the models for question synthesis including using the input data, user profile including user preferences, and/or other gathered information to form a request or use the data to prompt the model to generate a response to the user that is structured in a way that answers the request and/or may be positively received by the user.

The profile module 114 may also be configured to read data retrieved by the models such as, for example, data corresponding to the services of the service providers, and select relevant information to return to the end user. For example, the relevant information returned to the user in the service profile may include portions of text describing a sub-category identified in the retrieved data based on the user preferences.

The profile module 114 may determine a relevance score to embeddings in the retrieved data and the relevant information provided to the user in the service profiles may be based on the relevance scores. Additionally, if the data obtained from the data source is not relevant (i.e. low relevancy score) to the user inputs and/or the user profile, the profile module 114 may be configured to re-form the query to retrieve new data corresponding to the third party service providers 130 from the data source to try and get a better answer. The model may also continue this process until the retrieved data, or portions thereof, exceeds a relevancy threshold representative of an adequate reply. In some embodiments, the profile module 114 may retry the attempt a certain threshold number of times before escalating the failure. For example, the recommendation system 105 and/or the profile module 114 may re-form the query for retrieving data from the data source up to three times before escalating the failure or determining the retrieved data has a relevancy score exceeding a certain threshold. Accordingly, if the response fails the threshold number of attempts, the recommendation system 105 and/or system 100 may, for example, generate an alert at a network computing device, forward the alert to a human service agent, among other actions.

The profile module 114 may utilize the models to process the data retrieved from the other networks including determining relevant data, or portions thereof, in the retrieved data based on relevancy scores determined based on attributes of the user profile representative of the query and characteristics of the retrieved data. In addition, to facilitate reducing the amount of data that is returned in response to a query, the models may refine the data using one or more techniques. In some embodiments, the models may refine the data based on the relevancy score. For example, data retrieved from certain sources (e.g., preferred websites) can be weighted to have a higher relevancy score from other sources (e.g., non-preferred websites) to facilitate suppressing noise in the retrieved data and to limit the number of same results that may be included in the retrieved data.

The profile module 114 may utilize the models to determine a relevancy scoring. The models can apply one or more techniques and/or algorithms to determine the relevancy score by determining a similarity between data of the user profile and the retrieved data. In some embodiments, determining the similarity can include calculating a cosine similarity with vector representations between the user profile and the retrieved data. In some embodiments, the similarity can include calculating a cosine similarity with vector representations of the embeddings representative of the user profile and embeddings representative of at least one of the retrieved data, summaries, service profiles, or any combination thereof. For example, the cosine similarity calculations may be representative of a textual similarity between the user profile and the service profiles. A higher similarity score indicates a more relevant response.

The profile module 114 may utilize the one or more model techniques and/or methodologies to parse through the corpus of retrieved data and generate summaries based on the purpose or objective of the user determined from the user inputs. In some embodiments, the summaries may include portions of the retrieved data. For example, a summary may include one or more portions of data extracted from a certain webpage. The summaries may then be utilized to identify third party service providers 130 candidates based on the identified category. That is, the profile module 114 may generate the service profiles 116 from the summaries.

The profile module 114 may refine the retrieved data one or more times to generate progressively refined summaries that may be utilized to generate the service profiles 116. For example, the profile module 114 applies the model to the retrieved data to generate a first summary, the model is applied to the first summary to generate a second summary, and so forth. This process may be repeated one or more times to generate progressively refined summaries of, for example, third party service providers 130 in an identified category, a particular third party service provider 130, a location, among other examples. Each summary including therein data, or portions thereof, from the previous summary that may be dynamically generated by the model based on one or more model parameters. For example, the model may be applied to a summary including data of a plurality of third party service providers 130 to generate a refined summary for one of the third party service providers 130, and a service profiles 116 may be generated from the refined summary.

The profile module 114 may utilize the models to read selected results (e.g., summaries) against the user profile and extract, for example, a list of locations or topics from the retrieved data that may be relevant to the user profile. Accordingly, the models can output, for example, a list of locations, topics, or other data with details of the location or topics such as the name, text explaining why the location was picked, match score, other metadata details, other like data, or any combination thereof. This may be done for one or more service profiles. For example, the service profiles may be determined from 10 pieces of scraped content or vector DB results.

The profile module 114 may utilize the models for performing an identity resolution process that ensures the locations or topics included in the service profiles 116 that are sent to users in response to queries is the actual location or topic. Accordingly, the model may generate another query for determining the actual location or topic of, for example, the third party service provider 130 from a network of the third party service provider 130. Once the actual location data is obtained, the data can be combined and/or compared with the data in the initial retrieved data and/or the service profile representative of the third party service provider 130 to enable the model to form a combined opinion as output on the location or topic in the service profile 116.

The profile module 114 may utilize the models to perform keyword matching. Keyword matching includes identifying key terms in the user's input query, and checking for the presence of the same or similar words in the data of the third party service providers 130 retrieved using the API. For example, if a user asks about “dog-friendly hotels in Miami,” the model can determine the relevancy of the response based on the presence of keywords such as “dog-friendly,” “hotel,” and “Miami.” In another example, if a user asks about “dog-friendly hotels in Chicago, the model can determine the meaning of the user input and generate a query for retrieving data in response to the query. The more keyword matches, the higher the relevance score.

The profile module 114 may also establish a threshold limit for the relevance score of responses. If the calculated relevancy score for the retrieved data, or portions thereof, surpasses this threshold, the profile module 114 may extract relevant portions of data and combine it into a corresponding service profile. If the retrieved data does not exceed the threshold, the profile module 114 and/or the recommendation system 105 can reformulate the query, make a new request, notify the user about the low relevance, generate a follow-up response that may be sent to the user device to obtain clarification of the query, among other operations.

The functional modules 112, 113, 114, 117, 118, and 119 of the recommendation system 105 may include a matching module 117 configured to determine a service profile(s) 116 that corresponds with a user profile 115. The matching module 117 may apply the one or more model techniques and/or methodologies to determine a similarity between the user profile 115 and the service profiles 116 based on the user inputs and the user's preferences. The model techniques may include one or more NLP techniques to understand the data of the user profile 115 and the service profiles 116 to determine matches between the user profile 115 and each of the service profiles 116. In some embodiments, the model techniques may include one or more distance metrics applied to the data of the user profile 115 and the service profiles 116 to determine similarities between the respective datasets.

The matching module 117 may utilize any suitable distance metric (e.g., cosign similarity) to determine similarities between the user profile 115 and the service profiles 116 so as to determine the service profiles 116 that “match” the user profile 115. In some embodiments, the distance metric may determine similarities of respective embeddings in the user profile 115 and prospective service profile(s) 116, and may determine a “match” as any pair within a threshold distance, according to some embodiments. In some embodiments, the matching module 117 may determine a “match” based on a similarity score between the user profile 115 and the service profiles 116, which may synthesize the distance metric with another applicable similarity calculation (e.g., a natural language-based similarity calculation, etc.). In some embodiments, the similarity score between the user profile 115 and a particular service profile 116 may be based on a number of embedding pairs that exceed the distance threshold. The matching module 117 may determine that a particular service profile 116 is a “match” to the user profile 115 in response to the similarity score exceeding a threshold value.

The functional modules 112, 113, 114, 117, 118, and 119 of the recommendation system 105 may include a display module 118 configured to display (e.g., on the GUI 126) the service(s) associated with the service profile(s) 116 determined by the matching module 117. In addition to displaying the service and details regarding the service, the display module 118 may also generate one or more interactive elements that enable the user to select, view more, rate, or otherwise interact with the displayed service. For example, the interactive elements may correspond to the service profiles 116. In another example, the interactive elements may be follow-up requests for additional user inputs to reform queries for retrieving data from the data source. These interactive elements may be in coordination with the third party service provider 130, such that the interaction with the displayed service may be passed along or forwarded to the third party service provider. For example, if the interactive element enables a user to add the displayed service to a planned trip, the display module 118 may send an indication of this selection to the third party service provider 130, which may book or reserve the service for the user.

The functional modules 112, 113, 114, 117, 118, and 119 of the recommendation system 105 may include a feedback module 119 that adjusts at least one of the user profiles 115 and/or the service profiles 116 based on input from the user regarding the service(s) displayed by the display module 118. The input may be a user's impression of the displayed service, which may be received via a dedicated preference prompt, and may be a user's interaction with the displayed service. For example, if the user books the displayed service, the feedback module 119 may adjust the user profile 115 to reflect the positive match. For example, if the user books the displayed service, the feedback module 119 may adjust the user profile 115 to reflect the positive match by updating one or more weights associated with corresponding features in the user profile 115.

The feedback module 119 may be configured to identify feedback data in the data retrieved from a data store in response to the query, and the service profiles 116 may include this feedback data. For example, the service profiles 116 displayed at the user device 120 may include text extracted from the retrieved data corresponding to positive recent reviews from other users or summaries of the reviews.

In response to the recommendation system 105 obtaining user inputs from a user or a user device of the user, the one or more functional modules 112, 113, 114, 117, 118, and 119 can utilize the trained machine learning model or models of the recommendation system 105 and to perform operations including, but not limited to, obtain a user input from a user device 120 of a particular user, identify categories based on the user input, extract a query from the user input, refine the query, obtain data corresponding to an identified category from a data source, generate summaries of the retrieved data, generate service profiles 116 for the identified category, and determine a match between the user profile 115 and the respective service profiles 116. The service profiles 116 may include, for example, text data, image data, location data, customer review data, attribute data, one or more portions thereof, or any combination thereof.

The service profiles 116 for each identified category may be send to the user device 120 to provide the user with tailored recommendations in response to the user's query request. The service profiles 116 may include data extracted from the summary and/or the retrieved data that may be related to the user's input and the user's preferences. For example, a service profile 116 for a hotel may include text data corresponding to summaries, or portions thereof, describing certain hotel amenities requested by the user in the user inputs. In some embodiments, the recommendation system 105 may send an output dataset including the one or more service profiles 116 to the user device 120. In some embodiments, the recommendation system 105 may display the one or more service profiles 116 on, for example, a web browser to be displayed by a display of the user computing device.

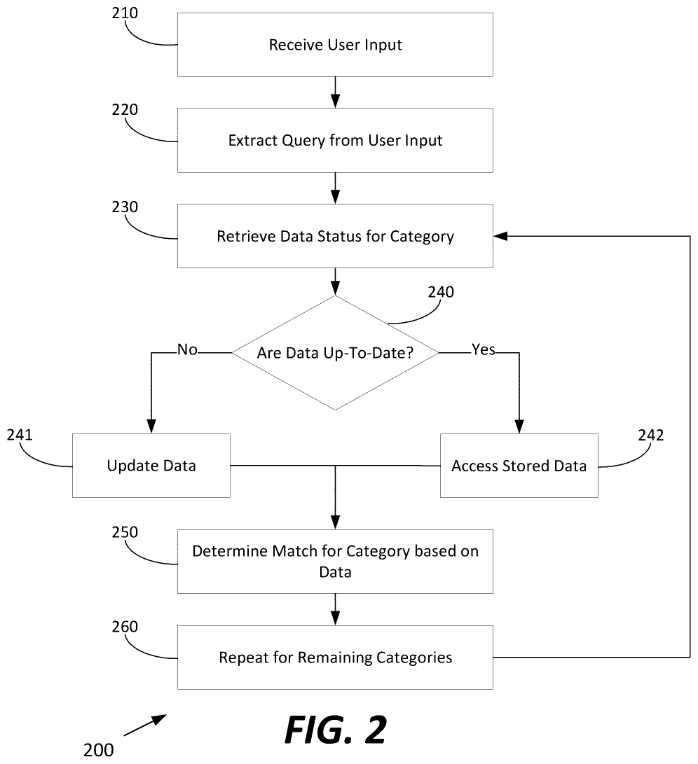

FIG. 2 is a flow chart illustrating an example method 200 of determining a match for a particular user. The method 200, or one or more portions of the method 200, may be performed by system 100 and particularly the matching module 117 (shown in FIG. 1), in some embodiments.

The method 200 may include, at block 210, receiving a user input. The user input may be a request for a particular service, or may outline a user's general requirements. As such, the user input may be specific (e.g., “I'd like to stay in the nicest hotel in Amsterdam that has a pool.”) or broad (e.g., “I'd like to get out of town for the weekend.”).

The method 200 may also include, at block 220, extracting a query from the user input. The query may be extracted based on determining an objective or purpose of the user's request determined based on the user inputs.

The method 200 may also include refining the query. In some embodiments, refining the query includes enriching the query based on a user profile 115. In some embodiments, refining the query include enriching the query based on the user's preferences. In some embodiments, a user profile 115 associated with the user making the input may be retrieved, and the user profile 115 may be leveraged to refine the query. In some embodiments, the extracted query may form or be part of the user profile 115. The extracted query may be representative of a goal or desired result of the user input. Using the example above of a broad user input, the extracted query may be “What is a relaxing city within 100 miles of the user's location?,” which takes into account a predicted intent of the initial input. This extracted query may then inform or be refined by the user profile 115. For example, if the extracted query is “What is the best hotel in Amsterdam?”, the method 200 may utilize data from the user profile to inform the meaning of “best” as posited by the query.

The method 200 may further include, at block 230, retrieving a status of data associated with each category of service. Data for each category may be stored in the memory 111, and retrieving a status of the data may include determining a date of the most recent update made to the stored data (e.g., when were the data last pulled). In response to the date being less than a threshold amount of time from present day (e.g., the data were last updated relatively recently), the method 200 may proceed to block 242 to access the stored data. In response to the date being greater than a threshold amount of time from present day (e.g., the data were last updated a relatively long time ago), the method 200 may proceed to block 241 to update the data by retrieving new datapoints for the category. For example, if the category is “class offerings for second semester,” curriculum guides for the second semester may be pulled from the appropriate source.

The method 200 may further include, at block 250, determining a match for the category based on these data (from either of blocks 241 or 242), which may be used to generate a service profile(s). As described above, the match may be based on a similarity score or distance metric between the extracted user query (enhanced by the user profile 115) and each respective service profile 116. The method may include, at block 260, repeating each of steps 230-250 for each category.

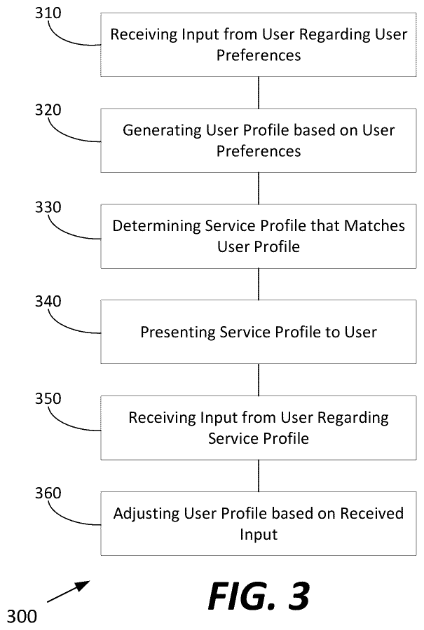

FIG. 3 is a flow chart illustrating an example method 300 of profile-based service recommendation. The method 300, or one or more portions of the method 300, may be performed by system 100 and particularly the recommendation system 105 (shown in FIG. 1), in some embodiments. The method 300 may be an embodiment of blocks 210, 220, 230, 240, 241, 242, 250, 260, or portions thereof, of method 200.

The method 300 may include, at block 310, receiving a user input from a user regarding user preferences. The user input may be a request for a particular service, or may outline a user's general requirements. As such, the user input may be specific (e.g., “I'd like to stay in the nicest hotel in Amsterdam that has a pool.”) or broad (e.g., “I'd like to get out of town for the weekend.”). In some embodiments, the user input may be a request for different categories of services. For example, the user input may request different services (e.g., “Find me flights to Paris and hotels near [this local point of interest].”).

The method 300 may also include, at block 320, generating a user profile based on user preferences. The user profile may be generated, for example, based on user inputs when the user is creating a user account in a recommendation system. In some embodiments, the user profile may be generated at or near a same time period as when the user inputs for recommendations for services is obtained from the user computing device. For example, the user's preferences can be the user's preferred seat location on an airplane (e.g., aisle, window, and/or middle seat, exit row seat, etc.).

The method 300 may include, at block 330, determining service profiles that matches the user profile. As described above, the match may be based on a distance metric between the user profile 115 and each respective service profile 116. In some embodiments, the match may be based on a distance metric between the user profile 115 refined based on the extracted query and each respective service profile 116. In some embodiments, the match may be based on a similarity calculation between the user profile 115 and each respective service profile 116.

One or more user profiles may be determined by the recommendation system 105 for a given user. The one or more user profiles can be stored in, for example, memory 111 of the recommendation system 105 in FIG. 1. The one or more user profiles may include a user profile representative of the user's preferences. The user's preferences may be leveraged to refine a query extracted from the user inputs. In some embodiments, the user profile representative of the user's preferences may be retrieved from a data store of the recommendation system 105, and may then be leveraged to refine the query. For example, the user profile representative of the user's preferences may have been generated when the user created a user account in the recommendation system 105. The one or more user profiles can include a user profile representative of the extracted query. In some embodiments, the user profile representative of the extracted query can be refined using the user profile representative of the user preferences. In some embodiments, the embeddings representative of the user profile of the extracted query can be refined using the embeddings representative of the user profile of the user preferences.

In some embodiments, the extracted query may be representative of a goal or desired result of the user input. This extracted query may then inform or be refined by the recommendation system 105 to determine the corresponding user profile representative of the extracted query based on the user profile representative of the user's preferences. For example, if the extracted query is “What is the best hotel in Amsterdam?”, the method 200 may utilize data from the user profile representative of the user's preferences to inform the meaning of “best” as posited by the query.

Using the example above of a broad user input of “What is a relaxing city within 100 miles of [the user's location]?,” one or more machine learning techniques and/or algorithms can be utilized to perform operations including, but not limited to, obtain the user inputs, predict an intent of the user inputs, extract the query from the user input representative of a determined goal or desired result of the query, determine a user profile based on the extracted query and/or based on a user profile of the user's preferences. The intent of the user inputs may be predicted by understanding a meaning of the user inputs. In some embodiments, the intent of the user inputs may be predicted by learning a grammar of the user inputs based on determining a semantics and morphology. The one or more machine learning techniques and/or algorithms may also be utilized to generate a user profile based on the extracted query and the user's preferences, identify one or more services from a data source based on the user profile, generate service profiles for the one or more services, determine a match between the user profile and the service profiles.

The method 300 may include, at block 340, presenting a service profile 116 to the user. The service profile 116 may be associated with a particular service provider in a category determined based on the user inputs. In some embodiments, a plurality of service profiles 116 may be presented to the user, each service profile 116 being associated with a respective service provider in the category. In some embodiments, one or more categories for recommendation may be identified from the user inputs, and for each category, one or more service profiles 116 may be presented to the user.

The method 300 may include, at block 350, receiving input from the user regarding the service profile 116. The input may be based on the user behavior. For example, the user behavior may be from the user interacting with an interactive element representative of the service profile in a web browser application displayed at the user computing device. The input may be the user completing a sequence of steps at the user computing device. For example, the input may be based on the user completing a sequence of steps including the user interacting with the interactive element, adding the displayed service to a planned trip, completing an electronic transaction with the service provider associated with the service profile representative of the user booking or reserving the service, among other inputs.

The method 300 may include, at block 360, adjusting the user profile based on the received input. Adjusting the user profile may include refining the user profile based on the received input. In some embodiments, adjusting the user profile may include updating the embedding values representative of the user profile. In other embodiments, adjusting the user profiles may include updating one or more weights associated with the embeddings representative of the user profile.

In some embodiments, the adjustment to user profile at block 360 may include feedback from a user regarding a quality or regarding the user's interest in the presented service profile. In addition to adjusting the user profile, the method 300 may also include repeating portions of the method 300 in order to provide additional service profile(s) if the user's input indicates a lack of interest.

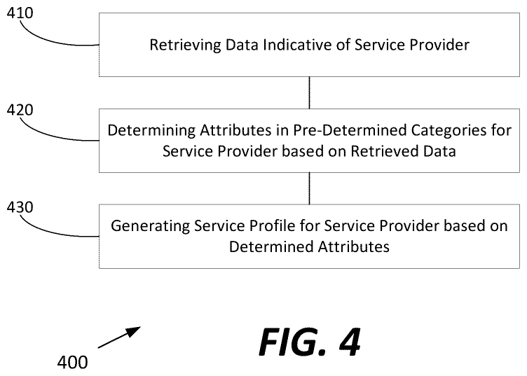

FIG. 4 is a flow chart illustrating an example method 400 of providing profile-based service recommendations. The method 400, or one or more portions of the method 400, may be performed by system 100 and particularly the recommendation system 105 (shown in FIG. 1), in some embodiments. The method 400 may be an embodiment of blocks 230, 240, 241, 242, 250, 260, or portions thereof, of method 200. The method 400 may be an embodiment of blocks 330, 340, 350, 360, or portions thereof, of method 300.

The method 400 may include, at block 410, retrieving data indicative of a service provider. In some embodiments, the data may be indicative of one or more services of the service provider. In some embodiments, the data may include, but is not limited to, text data, image data, audio data, other electronic types of data, or any combination thereof.

The data may be obtained from a data source. In some embodiments, the data source may be the memory 111 of the recommendation system 105. In other embodiments, the data source may be a data store in a networked system of the recommendation system 105. In some embodiments, the data source may be a third party service provider 130. The data may be retrieved from the network associated with the third party service provider 130. For example, the data source may be a third party service provider 130, and the data may be retrieved from a web page (e.g., data scraping) obtained from a network of the third party service provider 130 using a web browser application. In some embodiments, the data source may be from a plurality of third party service providers 130.

The method 400 may include, at block 420, determining attributes in pre-determined categories for a service provider based on the retrieved data. The categories may be determined based on the query. In some embodiments, the categories may be based on the refined query. In some embodiments, the categories may be determined by applying the one or more machine learning models and/or techniques to the user inputs, query, refined query, service profiles, or any combination thereof. In some embodiments, the pre-determined categories may be questions or prompts configured to be answered or satisfied by characteristics of the services in the retrieved data. For example, the pre-determined categories may include hotels, investment opportunities, academic services, culinary services, points of interest, etc. These pre-determined categories may be established by a user directly (e.g., the categories themselves are explicitly defined by the user device 120) or may be derived from a user input (e.g., like the queries of method 300). In some embodiments, the pre-determined categories may be sub-categories of a category. For example, the category may be hotels and the pre-determined categories may be interactive elements indicative of amenities offered by the hotel including “spa,” “pool,” “restaurants,” “dry cleaning,” “business center,” “conference rooms,” etc., and the one or more machine learning techniques and/or algorithms may be applied to the retrieved data to determine the embeddings in the retrieved data of the service provider(s) that may be associated with the pre-determined categories based on the attributes associated with the retrieved data.

In some embodiments, determining the attributes in the pre-determined categories includes refining the retrieved data. The retrieved data may be refined one or more times using a model to generate progressively refined summaries that may be utilized to generate the service profiles 116. This process may be repeated one or more times to generate progressively refined summaries of, for example, third party service providers 130 in the pre-determined categories. In some embodiments, each summary may include therein data, or portions thereof, from the previous summary that may be dynamically generated by the model based on one or more model parameters. For example, the model may be applied to a summary including data of a plurality of third party service providers 130 to generate a refined summary for one of the third party service providers 130, and a corresponding service profiles 116 representative of the third party service provider 130 may be generated from the refined summary.

The method 400 may include, at block 430, generating service profiles for service providers based on determined attributes. The characteristics of the services in the retrieved data included in the service profiles 116 may be based on the determined attributes. That is, the one or more machine learning techniques and/or algorithms can be applied to the retrieved data to determine the characteristics of the services of a service provider to include in the service profiles 116 based on the attributes associated with the embeddings representative of the services. In some embodiments, the model techniques may be applied to the retrieved data to extract metadata of the services to include in the service profile 116.

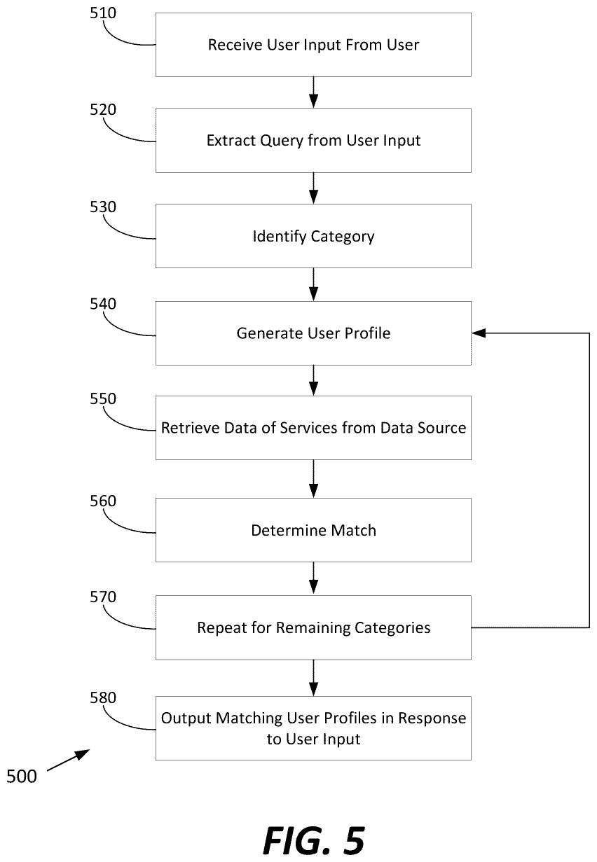

FIG. 5 is a flow chart illustrating an example method 500 of providing profile-based service recommendations. The method 500, or one or more portions of the method 500, may be performed by system 100 and particularly the recommendation system 105 (shown in FIG. 1), in some embodiments. The method 500 may be an embodiment of blocks 210, 220, 230, 240, 241, 242, 250, 260, or portions thereof, of method 200. The method 500 may be an embodiment of blocks 310, 320, 330, 340, 350, 360, or portions thereof, of method 300. The method 500 may be an embodiment of blocks 410, 420, 430, or portions thereof, of method 400.

The method 500 includes, at block 510, receiving user input from a user. The user input corresponds to a request for services in a category or in one or more categories. The user can be one of a plurality of users of recommendation system 105. That is, the recommendation system 105 can simultaneously process user queries in parallel, according to some embodiments. The user can provide the input at user device 120, and the recommendation system 105 may obtain the user inputs from user device 120. In some embodiments, the user input can be input into a user interface such as, for example, an interface displayed at user device 120 associated with the user. For example, the user input can be received based on the user's interactions with a web browser application displayed at the user device 120. In another example, the user input can be received from another network via an API. In some embodiments, the user device 120 may be in electronic communication with the recommendation system 105 and the user input may be obtained from the user device 120. In other embodiments, the user inputs may be obtained from the user device 120 using an API. In some embodiments, the user device 120 may be electronic communication with a network of another entity such as, for example, a network of a travel service provider, and the user inputs may be obtained from a computing device of the other entity using an API and the service profiles 116 may be sent by the recommendation system 105 to the other network using the API as response to the user inputs.

The method 500 includes, at block 520, extracting a query from user input. The query can be determined based on processing the user input data obtained by recommendation system 105 from user device 120. In some embodiments, the query can include data representative of pre-determined categories. That is, the categories can be determined based on the extracted query, the user inputs, or both. In some embodiments, the model may determine, based on the inputs from the user and the user's profile, specific and nuanced parameters for generating the queries and retrieving data in response to the user's request.

In some embodiments, extracting the query from the user input from the user can include retrieving a user profile (e.g., third user profile) representative of preferences of the user from a data store based on the user input, and refining the extracted query with the user profile representative of the preferences of the user. In some embodiments, the extracted query is representative of a defined objective of the user. In some embodiments, the user profile representative of preferences of the user can be obtained from a data store based on the user input. For example, the data store can be memory 111 of recommendation system 105. In another example, the data store can be a memory device in a network of the recommendation system 105.

In some embodiments, the extracted query is representative of a defined objective of the user.

The method 500 includes, at block 530, identifying a category. The identified category may be determined from the user input, the extracted query, or both. In some embodiments, the method 500 includes identifying one or more categories of services based on the user input. In other embodiments, the method 500 includes identifying the categories of services based on the query. In some embodiments, the category may include at least one category.

In some embodiments, the query may be generated based on the identified category. In some embodiments, the query may be a request for data corresponding to the identified category of service. In other embodiments, the query may be at least one request for data corresponding to the at least one category. The retrieved data of the services can be for the identified category.

The method 500 includes, at block 530, generating a user profile representative of the query. In some embodiments, the user profile can include the preferences of the user. In some embodiments, the user profile can be obtained from a data store of the recommendation system 105 and the user profile can be updated to include the extracted query.

In some embodiments, the method 500 may include retrieving the user profile representative of the preferences of the user from a data store of the recommendation system 105 (e.g., first data store) and refining the extracted query with the preferences of the user. In some embodiments, the user profile can be updated with data of the query to enable the recommendation system 105 to determine matches between the refined user profile and the determined service profiles. In some embodiments, the recommendation system 105 may generate a user profile including the user's preferences, combine the query parameters with the user profile, and the recommendation system 105 may determine matches between the user profile and the generated service profiles.

In some embodiments, the method 500 may include extracting a first set of embeddings representative of the user profile, extracting a second set of embeddings representative of the preferences in the respective service profile, applying a distance metric to determine a match between the user profile and the respective service profile. In some embodiments, determining the match includes applying the distance matric to the first set of embeddings and the second set of embeddings to determine the match between the user profile and the respective service profile. In some embodiments, the distance metric is a similarity score calculated for the user profile and the service profiles based on respective embeddings.

The method 500 includes, at block 550, retrieving data corresponding to services. In some embodiments, the method 500 includes generating a service profile for each respective service. The services in the retrieved data may be based on the identified category. That is, each query for retrieving data from a data source may be for services in a respective category. In some embodiments, the services may be for at least one of services, locations, objectives, or any combination thereof. In some embodiments, the services may be for services of third party service providers 130. In other embodiments, the services may be related to other information that can be extracted from a corpus of data. For example, the service profiles may be for a group trip planning for a plurality of users, and the user profiles and inputs from each of the plurality of users can be used to generate the queries, retrieve data corresponding to the services, and to generate the service profiles.

It is to be appreciated that the services are not intended to be limited to services, locations, objectives, and the like, and may relate to any of a plurality of other topics that can be learned from a corpus of data using the embodiments of the present disclosure.

In some embodiments, the retrieved data can be obtained from a data store of another network. In other embodiments, the data store can be located in one or more other networks and the recommendation system 105 may generate a respective query to retrieve data from each data store. In some embodiments, the other network may be associated with the third party service provider 130. In some embodiments, the retrieved data can be obtained from the respective third party service provider 130 using one or more other networks. For example, the data of the services in a certain category may be retrieved from a search engine in response to the query.

The data source may be a local data store in the recommendation system 105. In some embodiments, the data store may be in a computing device in a network of the recommendation system 105. In some embodiments, retrieving the data corresponding to the services in the identified category from the data source may include determining a status of the retrieved data of the services. In some embodiments, the status of the retrieved data may be determined based on timestamp data. The timestamp data may be representative of a most recent update to the retrieved data.

The method 500 includes, at block 560, determining a match between the user profile and the service profiles. In some embodiments, the method 500 may include determining a match between the user profile and each service profile generated based on the retrieved data.

The method 500 may also include generating a service profile for one or more services in the retrieved data. Service profiles may be generated for each service based on a relevancy of the data corresponding to the service. That is, based on a similarity between the data corresponding to attributes in the user profile and the data corresponding to attributes of the service, a service profile may be generated for the service and compared with the user profile. In some embodiments, a service profile may be generated for the service based on a similarity between the user profile and the data corresponding to the service exceeding a threshold value. In some embodiments, the service profiles may be generated based on at least one of the extracted data, summary of the retrieved data, a refined summary, other data, or any combination thereof.

In some embodiments, determining the match between the user profile and the service profiles includes determining the first set of embeddings representative of the user profile, extracting a second set of embeddings representative of a respective service profile, and applying a distance metric to determine a match between the user profile and the respective service profile. In some embodiments, the distance metric is a similarity score calculated for the user profile and the service profiles based on respective embeddings. In other embodiments, determining the match between the user profile and the service profiles includes understanding the meaning and purpose of the user profile data and the service profile data, and determining a similarity between the user profile and the service profiles based on a context of the data.

The method 500 also includes, at block 570, generating an output dataset corresponding to one or more service profiles in the at least one category determined from the matching. In some embodiments, the method 500 can also include displaying the matching service profiles at a display of the user device 120. In some embodiments, the method 500 may further include obtaining feedback data in response to the user of user device 120 interacting with the service profiles in the output dataset. The feedback data may be obtained by the recommendation system 105 and stored in the data store of the recommendation system 105. In some embodiments, the feedback data may be utilized to update the user profile. In some embodiments, the feedback data may be utilized to further train the model

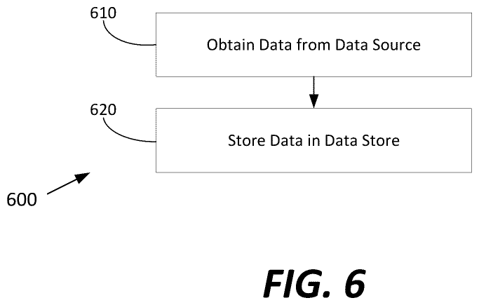

FIG. 6 is a flow chart illustrating an example method 600 of obtaining data of service providers from a data source. The method 600, or one or more portions of the method 600, may be performed by system 100 and particularly the recommendation system 105 (shown in FIG. 1), in some embodiments.

The method 600 may be an embodiment of blocks 230, 240, 241, 242, or portions thereof, of method 200. The method 600 may be an embodiment of blocks 320, 330, 340, or portions thereof, of method 300. The method 600 may be an embodiment of blocks 410, 420, 430, or portions thereof, of method 400. The method 600 may be an embodiment of blocks 540, 550, or portions thereof, of method 500.

The method 600 may include, at block 602, obtaining data from data source. The data source may be a network external to a network of recommendation system 105. That is, the data of the services, which may include the services of the service provider, may be obtained from a network external to the network of the recommendation system 105 as shown in FIG. 1. The other network may be associated with another entity. In some embodiments, the other network may be a network of the third party service provider 130. In some embodiments, obtaining the data from the data source may include obtain the data corresponding to the services in the identified category from each of one or more other networks. The data of the services may also be obtained from a network associated with, for example, a search engine that may be utilized for retrieving the data of the services from the respective networks associated with each of the services. For example, the data of the services can be obtained from networks of the third party service providers 130 using the search engine.

The method 600 may include, at block 604, storing the data in a data store. The data store may be in the network of the recommendation system 105. In some embodiments, the data store may be memory 111. In other embodiments, the data store may be a memory device external to recommendation system 105. In some embodiments, the data store may be located in the network of recommendation system 105.

The data stored in the data store may include the data obtained from the other network or networks corresponding to the services. In some embodiments, the data stored in the data store may include the service profiles representative of the services generated from the retrieved data based on the query, the user profile, or both. That is, data obtained by recommendation system 105 during fulfillment of the extracted queries can be utilized to build a dataset to enable recommendation system 105 to provide the services profiles representative of the services. For example, in response to a user input, recommendation system 105 may utilize the data corresponding to the services that is stored in memory 111 to generate the service profiles representative of the services in the identified category, and matches between the user profile and these service profiles may be provided to the user device 120 as recommendations in the output dataset. In another example, a time period for matching service profiles in the identified category and the user profile of the request may exceed a defined threshold limit and the recommendation system 105 may utilize the data, or portions thereof, in the local data store to provide the profile-based recommendations of service profiles.

In some embodiments, the match may be determined based on the embeddings representative of the user profile and the embeddings representative of a respective service profile.

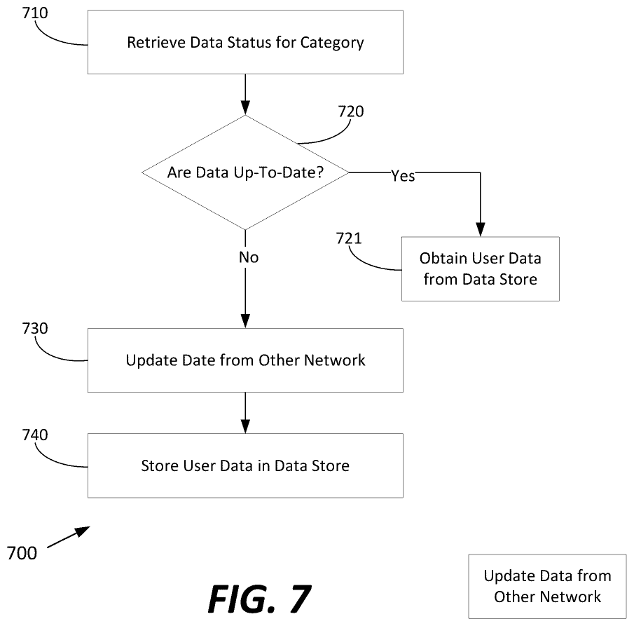

FIG. 7 is a flow chart illustrating an example method 700 of obtaining data of service providers from a data source. The method 700, or one or more portions of the method 700, may be performed by system 100 and particularly the recommendation system 105 (shown in FIG. 1), in some embodiments.

The method 700 may be an embodiment of blocks 230, 240, 241, 242, or portions thereof, of method 200. The method 700 may be an embodiment of blocks 320, 330, 340, or portions thereof, of method 300. The method 700 may be an embodiment of blocks 410, 420, 430, or portions thereof, of method 400. The method 700 may be an embodiment of blocks 540, 550, or portions thereof, of method 500. The method 700 may be an embodiment of blocks 610, 620, or portions thereof, of method 600.

The method 700 includes, at block 710, retrieving data status for a category. In some embodiments, the data status may be a timestamp data representative of a most recent update to the respective data. The data status enables the recommendation system 105 to monitor the data of the services in the data store, verify the data status is below a defined threshold limit to ensure the information is current and up-to-date. If the data status does not exceed the defined threshold limit, the data may be utilized to generate the the service profiles in response to the user input, and one or more of the service profiles may be included in the output dataset based on the service profiles matching the user profile.

In some embodiments, the data status may include determining if the data store of the recommendation system 105 and/or a network of the recommendation system 105 includes data that can be utilized to answer the query. If the data store includes relevant data, then the recommendation system 105 may retrieve the data to generate the service profiles 16. If there is a gap in the data, the recommendation system 105 may generate the queries for retrieving the data from the data source(s) in the one or more other networks. The retrieved data from the other data sources can then be utilized to supplement the local data to build the local data.

The method 700 may include, at block 720, determining a status of the data is up to date. The data may correspond to the services. In some embodiments, the status of the data may be determined based on timestamp data. The timestamp data may be representative of a most recent update to data in data store. The data status may be utilized by recommendation system 105 to determine if the data in the local data store needs updating. For example, the recommendation system 105 may, in response to the data status exceeding a defined threshold limit, the recommendation system 105 may retrieve data of the corresponding services from data stores of other networks to generate the service profiles and update the data in the local data store. For example, the data can be flight data for an airline service provider that is regularly updated at certain intervals based on the timestamp data to enable the data in the service profiles to include current data for the service. In another example, the data can include customer reviews of a hotel service provider that is updated when the timestamp data has exceeded a defined threshold limit to update the customer reviews of the hotel service provider to ensure the service profile(s) associated with the hotel includes up-to-date data and to facilitate improved matching than compared with using a static dataset.

The method 700 includes, at block 721, in response to determining the data is up to date, the recommendation system 105 may obtain the data in the local data store of the recommendation system 105 such as, for example, from memory 111. The data obtained from data store may then be utilized to generate the service profiles. In some embodiments, the data from the local data store of the recommendation system 105 may be utilized to enable the recommendation system 105 to continue performing the profile-based recommendations such as, for example, due to delays in retrieving data from data stores in the one or more other networks.

The method 700 includes, at block 730, in response to determining the data is not up to date, the recommendation system 105 may retrieve data from data stores located in one or more other networks. In some embodiments, determining the data is not up to date may include determining the timestamp data has exceeded a threshold limit. If the threshold limit of the timestamp data is exceeded, the recommendation system 105 may retrieve the data for the services from the data stores in the other networks external to the network of recommendation system 105. In some embodiments, the recommendation system 105 may retrieve data from the data stores in the other networks for the services in the at least one category based on determining the data in the local data store of these services do not include information that meets the objectives of the user input.

The method 700 may include, at 740, storing the data in the data store. That is the data obtained from the other networks of the services can be stored in the data store. In some embodiments, the service profiles representative of the services can be stored in the data store to enable improved efficiency in determining service profiles that match with the user profile. In some embodiments, the recommendation system 105 may determine the service profiles based on the data of the services stored in memory 111 and may then store the generated service profiles in the memory 111.

In some embodiments, one or more model techniques, methodologies, and/or algorithms can be applied to perform the method of the present disclosure including, but not limited to, to extract the query from the user input, generate a user profile representative of the query and the preferences of the user, identify a category, retrieve data corresponding to services in the identified category from a data source, generate service profiles, and determine a match between the user profile and the service profiles. In response to the user inputs, one or more of the service profiles in the category determined from the matching can be displayed at the user device associated with the user inputs. In some embodiments, the one or more model techniques may include, for example, NLP techniques to learn an objective of the user based on a context of the obtained user input data and to perform one or more steps of the methods 200, 300, 400, 500, 600, or 700.

In some embodiments, a method includes receiving, at a computing device in a network, a user input from a user, extracting, by the computing device, a query from the user input, identifying, by the computing device, at least one category based on the user input, generating, by the computing device, a user profile representative of the query and preferences of the user, retrieving, by the computing device, data corresponding to services in the identified at least one category from a data source and generating a service profile for each respective service, determining, by the computing device, a match between the user profile and the service profiles, and generating, by the computing device in response to the query, an output dataset corresponding to one or more service profiles in the at least one category determined from the matching.

In some embodiments, generating the user profile representative of the query and the preferences of the user further includes retrieving, by the computing device, the user profile includes the preferences of the user from a first data store, and refining, by the computing device, the extracted query with the preferences of the user. In some embodiments, the extracted query is representative of a defined objective of the user.

In some embodiments, the method, further includes determining, by a machine learning model, a first set of embeddings representative of the user profile, extracting, by the computing device, a second set of embeddings representative of a respective service profile, and applying, by the computing device, a distance metric to determine a match between the user profile and the respective service profile.

In some embodiments, the distance metric is a similarity score calculated for the user profile and the service profiles based on respective embeddings.

In some embodiments, retrieving the data corresponding to the services of the identified at least one category from the data source further includes determining, by the computing device, a status of the retrieved data. In some embodiments, the status is determined based on timestamp data representative of a most recent update to the retrieved data.

In some embodiments, the services correspond to at least one of services of a third party service provider, a location, and an objective.

In some embodiments, the user input corresponds to a request for services in the category.

In some embodiments, the data source is located in one or more other networks.

In some embodiments, a system includes a processor, and a non-transitory computer readable media having stored thereon instructions that are executable by the processor to perform operations including receive a user input from a user, extract a query from the user input, retrieve a user profile includes preferences of the user, refine the extracted query with the preferences of the user, retrieve data corresponding to services in an identified category from a data source and generating a service profile for each respective service, determine a match between the user profile and the service profiles, and generate, in response to the query, an output dataset corresponding to one or more service profiles in the category determined from the matching. In some embodiments, the extracted query is representative of a defined objective of the user.

In some embodiments, refining the extracted query with the preferences of the user includes determine a first set of embeddings representative of the user profile, determine a second set of embeddings representative of a respective service profile, apply a distance metric to determine a match between the user profile and the respective service profile. In some embodiments, the distance metric is a similarity score calculated for the user profile and the service profiles based on respective embeddings.

In some embodiments, retrieving the data corresponding to the services of the identified category from the data source further includes determine a status of the retrieved data. In some embodiments, the status is determined based on timestamp data representative of a most recent update to the retrieved data.

In some embodiments, the services correspond to at least one of services of a third party service provider, a location, and an objective.

In some embodiments, the user input corresponds to a request for services in the category.

In some embodiments, the data source includes one or more other networks.

In some embodiments, a non-transitory computer readable media having stored thereon instructions that are executable by a system to perform operations including receive a user input from a user, extract a query from the user input, identify at least one category based on the user input, determine a first set of embeddings representative of a user profile includes preferences of the user and the query, retrieve data corresponding to services in the identified at least one category from a data source and generating a service profile for each respective service, determine a match between the user profile and the service profiles.

In some embodiments, the instructions executable by the system further includes extract a second set of embeddings representative of a respective service profile, and apply a distance metric to determine a match between the user profile and the respective service profile.

In some embodiments, the distance metric is a similarity score calculated for the user profile and the service profiles based on respective embeddings.

In some embodiments, the instructions executable by the system further includes obtain the data corresponding to the services in the identified at least one category from one or more other networks, and store the service profiles in the identified at least one category in a data store.

In some embodiments, the instructions executable by the system further includes determine a status of the data corresponding to the services, update the service profiles in the data store in response to determining the status exceeds a threshold value, and the status is determined based on timestamp data representative of a most recent update to the data, the data store is in a network of the system.

In some embodiments, the services correspond to at least one of services of a third party service provider, a location, and an objective.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “text summarization” refers to techniques for generating a short summary of text such as, for example, in an electronic document.

As used herein, the term “sentiment analysis” refers to detecting a general sentiment based on text, images, videos, audio recordings, etc.

As used herein, the term “lemmatization” refers to breaking a word down to its root word and grouping inflected forms of the words with the same meaning together.

As used herein, the term “named entity recognition” refers to identifying named entities in text and classifying them into categories.

What is claimed is:

1. A method comprising:
receiving, at a computing device in a network, a user input from a user;
extracting, by the computing device, a query from the user input;
identifying, by the computing device, at least one category based on the user input;
generating, by the computing device, a user profile representative of the query and preferences of the user;
retrieving, by the computing device, data corresponding to services in the identified at least one category from a data source and generating a service profile for each respective service;
determining, by the computing device, a match between the user profile and the service profiles; and
generating, by the computing device in response to the query, an output dataset corresponding to one or more service profiles in the at least one category determined from the matching.

2. The method of claim 1, wherein generating the user profile representative of the query and the preferences of the user further comprises:
retrieving, by the computing device, the user profile including the preferences of the user from a first data store; and
refining, by the computing device, the extracted query with the preferences of the user;
wherein the extracted query is representative of a defined objective of the user.

3. The method of claim 2, further comprising:
determining, by a machine learning model, a first set of embeddings representative of the user profile,
extracting, by the computing device, a second set of embeddings representative of a respective service profile, and
applying, by the computing device, a distance metric to determine a match between the user profile and the respective service profile.

4. The method of claim 3, wherein the distance metric is a similarity score calculated for the user profile and the service profiles based on respective embeddings.

5. The method of claim 2, wherein retrieving the data corresponding to the services of the identified at least one category from the data source further comprises:
determining, by the computing device, a status of the retrieved data,
wherein the status is determined based on timestamp data representative of a most recent update to the retrieved data.

6. The method of claim 1, wherein the services correspond to at least one of services of a third party service provider, a location, and an objective.

7. The method of claim 1, wherein the user input corresponds to a request for services in the category.

8. The method of claim 1, wherein the data source is located in one or more other networks.

9. A system comprising:
a processor; and
a non-transitory computer readable media having stored thereon instructions that are executable by the processor to perform operations comprising:
receive a user input from a user;
extract a query from the user input;
retrieve a user profile including preferences of the user;
refine the extracted query with the preferences of the user;
retrieve data corresponding to services in an identified category from a data source and generating a service profile for each respective service;
determine a match between the user profile and the service profiles; and
generate, in response to the query, an output dataset corresponding to one or more service profiles in the identified category determined from the matching;
wherein the extracted query is representative of a defined objective of the user.

10. The system of claim 9, wherein refining the extracted query with the preferences of the user comprises:
determine a first set of embeddings representative of the user profile;
determine a second set of embeddings representative of a respective service profile, and
apply a distance metric to determine a match between the user profile and the respective service profile,
wherein the distance metric is a similarity score calculated for the user profile and the service profiles based on respective embeddings.

11. The system of claim 10, wherein retrieving the data corresponding to the services of the identified category from the data source further comprises:
determine a status of the retrieved data,
wherein the status is determined based on timestamp data representative of a most recent update to the retrieved data.

12. The system of claim 10, wherein the services correspond to at least one of services of a third party service provider, a location, and an objective.

13. The system of claim 9, wherein the user input corresponds to a request for services in the category.

14. The system of claim 9, wherein the data source comprises one or more other networks.

15. A non-transitory computer readable media having stored thereon instructions that are executable by a system to perform operations comprising:
receive a user input from a user;
extract a query from the user input;
identify at least one category based on the user input;
determine a first set of embeddings representative of a user profile including preferences of the user and the query;
retrieve data corresponding to services in the identified at least one category from a data source and generating a service profile for each respective service; and
determine a match between the user profile and the service profiles.

16. The non-transitory computer readable media of claim 15, wherein the instructions executable by the system further comprises:
extract a second set of embeddings representative of a respective service profile, and
apply a distance metric to determine a match between the user profile and the respective service profile.

17. The non-transitory computer readable media of claim 16, wherein the distance metric is a similarity score calculated for the user profile and the service profiles based on respective embeddings.

18. The non-transitory computer readable media of claim 16, wherein the instructions executable by the system further comprises:
obtain the data corresponding to the services in the identified at least one category from one or more other networks, and
store the service profiles in the identified at least one category in a data store.

19. The non-transitory computer readable media of claim 18, wherein the instructions executable by the system further comprises:
determine a status of the data corresponding to the services;
update the service profiles in the data store in response to determining the status exceeds a threshold value; and
wherein the status is determined based on timestamp data representative of a most recent update to the data,
wherein the data store is in a network of the system.

20. The non-transitory computer readable media of claim 15, wherein the services correspond to at least one of services of a third party service provider, a location, and an objective.
